(19) United States
(12) Patent Application Publication
(10) Pub. No.: US 2011/0272303 A1
(43) Pub. Date: Nov. 10, 2011

(54) STRUCTURE

(76) Inventor: Neil Terry Peterken, Tauranga (NZ)

(21) Appl. No.: 12/673,144

(22) PCT Filed: Aug. 14, 2008
(86) PCT No.: PCT/NZ2008/000211

§ 371 Date: Mar. 18, 2010

(30) Foreign Application Priority Data
Aug. 14, 2007 (NZ) 560570

(51) Int. Cl. B65D 69/00; B23P 11/00

(52) U.S. Cl. 206/223; 29/428; 220/495.01

(57) ABSTRACT

A method of constructing a structure, a structure constructed according to the method, and a kitset of parts. The structure may be a tank for holding liquids, or a temporary shelter for humans or animals.

### TECHNICAL FIELD

The present invention relates to methods and apparatus for the construction of structures and in particular, the construction of tanks for the storage and processing of materials.

### BACKGROUND ART

It is desirable in many situations to have a structure which can be easily constructed to hold substances or to provide temporary accommodation and housing for people and/or animals.

Given the need and benefits offered by such structures, there are a number of different systems known providing various options.

The traditional solution has been to transport preassembled or manufactured structures to the desired location. However, when a structure of large volume is required, this is often prohibitively costly as the volume of the structure significantly increases transport costs.

One solution to this problem has been to provide demountable or collapsible structures.

However, all suffer from inherent limitations including the intricate manner of their engineering, high relative cost, unsuitability for certain applications, or even failings to meet the purpose for which they are intended.

Reference will be made herein to a selection of relevant prior art by way of example of failings in these structures.

New Zealand Patent No. 211202 discloses free standing circular or oval enclosures for use as liquid or particulate storage tanks.

The walls of the tanks are formed from a series of modules, each module comprising an inner and an outer panel. The inner and outer panels are joined to each other so that they are available for connection to the panels of adjacent modules.

The method of connecting adjacent modules is fiddly and time consuming, with adjacent modules needing to be carefully aligned. This takes time and skill. Then, a bolt needs to be inserted through a recess and subsequently connected to a threaded nut on the inside of the tank. Therefore, a person may need to walk around the modules to gain access to and apply the bolt.

A series of stiffener means are attached to, or are integral with, the panels forming the modules. These vertical stiffener means are required to be connected to the modules which again increases the construction time of the structure and involves considerable effort by users.

A series of straps are then vertically spaced below the upper wall edge of the module to impart hoop strength to the structure. An upper hub structure is also required to restrain the upper wall edge reducing radial movement of the structure.

The combined effect of all the different component parts is that the structure is laborious to construct and install. Further, they require considerable effort to manufacture each individual part thereby increasing production costs.

New Zealand Patent No. 244107 is a modular liquid storage system, primarily directed for use as a hot water storage tank. The tank is formed from at least three interlocking or interconnectable segments moulded from a thermally insulated foam material. A thin flexible plastic sheet material is used to form a liner within the tank.

A tank such as this is not suitable for use as a large storage structure as it is unable to support its own weight and must be mounted in a bracket. This limits its application to uses other than as a domestic water storage tank.

Further, it is unlikely that the tank will have sufficient strength to hold and store a large amount of material.

New Zealand Patent No. 211683 discloses a storage tank formed from a series of panels, each panel having a number of vertical strengthening ribs. Adjacent panels overlap. Straps are laced through a series of loops in the panels about the diameter of the tank. The storage tank disclosed by this patent is fiddly and time consuming to assemble. It is impossible to easily connect adjacent panels and the tank is unstable prior to having the strap secured in place. As such, the tank is liable to collapse and hinder the construction process.

U.S. Pat. No. 4,760,932 discloses a collapsible fluid liquid storage tank.

The tank is formed from a number of cylinder shaped segments. Each cylinder segment is formed from wall panels connected along their side edges.

The cylinder segments are connected to each other using connectors positioned between the segments.

A base element has as a recess which will receive overlapping and flanged portions of bottom wall panels. The flanges of the bottom wall panels are gasketted into the recess to provide a fluid tight seal.

The walls of this tank are ridged and therefore heavy. The tank is accordingly difficult to transport.

In addition, the gasketting of the bottom wall panels into the base element makes it difficult to construct the tank.

With regard to the foregoing it would be advantageous to have a structure and method of constructing same which was easy to use, cost effective, and could be achieved with minimal tools or skill.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention, there is provided a method of constructing a structure, including the steps of:
(a) positioning a first base element with respect to where the structure is to be constructed;
(b) positioning a second base element adjacent to the first base element;
(c) positioning a first wall module such that it bears upon at least one of the base elements;
(d) positioning a second wall module adjacent to the first wall module such that it bears upon at least one of the base elements;
(e) repeating steps a-d to substantially form the shell of the structure;
   characterised by the step of inserting a portion of each base element into a recess of an adjacent base element.

According to a second aspect of the present invention, there is provided a structure built in accordance with the previous method.

According to another aspect of the present invention, there is provided a structure including:
(a) a plurality of base elements, and
(b) a plurality of wall modules, wherein each wall module bears upon at least one of the base elements,
   characterised in that a portion of each base element extends into a recess of an adjacent base element.

According to yet another aspect of the present invention, there is provided a kitset of parts for constructing a structure, the kitset including:
(a) at least two base elements;
(b) at least two wall modules;
   characterised in that a portion of each base element extends into a recess of an adjacent base element once the structure is constructed.

According to a fourth aspect of the preset invention, there is provided a base element for use with the method described herein,

the base element characterised in that it has a portion which can extend into a recess of an adjacent element when used in the method described above.

In a preferred embodiment, the present invention relates to a method and components to construct a cylinder shaped demountable tank.

Reference herein will be made to the structure as being a tank for holding liquids.

Alternatively, the structure may be a non-demountable tank, a tank for use in producing methane from effluent, a grain storage silio, a tank of other shapes, or a temporary shelter for humans or animals.

When utilised as temporary accommodation or shelter the structure is assembled as described herein using substantially similar components. However, in this embodiment, a bladder is not utilised and at least one wall panel may be altered to provide an entrance point into the structure. This will become apparent from the ensuing description.

In a preferred embodiment, the component parts of the present invention are formed from high density polyethylene plastic or similar materials. Alternatively the components of the present invention may be formed from aluminium, other plastic materials, or a combination of materials.

Throughout the body of the present specification the term “base element” refers to a component which provides support to the walls of the tank.

In a preferred embodiment, the base elements may be positioned substantially at the outside edge of the tank. In the embodiment where the tank is a cylinder, the base elements may be positioned substantially at the circumference of the tank.

In a preferred embodiment, the base elements may be a member having two recesses substantially perpendicular to each other. In this embodiment, one of the recesses may be configured to receive a portion of at least one wall module. The other recess may be configured to receive panels forming a floor of the tank.

Utilising this embodiment for the base elements is advantageous as the base elements can easily engage wall modules and floor panels as will be described in detail below. Further, the elements can be easily formed from moulding, extruding or folding sheet materials via known techniques.

Preferably, each base element may have a floor panel inserted into one of the recesses.

In this embodiment, the floor panel may overlap the edge of the base element such that it can extend into a recess of adjacent base elements.

The floor panel may be secured inside the recess prior to sale of the kitset, via known techniques such as plastic welding or traditional fasteners.

The use of floor panels with the present invention helps to improve the tank's stability, especially during its construction. In addition, using floor panels provides an intermediate barrier between a bladder (when used) and the ground below. This may help to prevent the bladder from being punctured or damaged by sharp objects.

This embodiment of the present invention is also advantageous as the base element and floor panels are easily manufactured and light weight. Further, they are of smaller dimensions than the base elements known in the prior art. The foregoing advantages mean that kitset of the parts used in constructing these tanks is smaller and more easily transported.

In addition, the base elements and floor panels can also be easily connected to each other before the kitset is sold. Therefore the tools needed to construct the tank are reduced.

Alternatively, the base elements may have corresponding male and female connectors adjacent to each other. These connectors can engage corresponding connectors of adjacent base elements to secure them to each other.

It is also envisaged that the tank could be constructed without using floor panels. In this embodiment the base elements may have a shape sufficient to help support the wall modules.

In a preferred embodiment, the base elements may provide a surface on which at least a portion of a wall module can bear.

Alternatively, the base elements may have a recess which can receive a substantially horizontal member extending from a wall module. In this embodiment the wall modules do not bear upon a surface of the base elements. Rather the base elements engage the wall module and help to stabilise this while the tank is being constructed.

Throughout the body of the present specification the term “wall module” should be understood as referring to a component which will provide a section of the walls of a tank.

Preferably, each wall module may have a recess and a protrusion on the side edges of the wall module. These features allow adjacent wall modules to be easily connected to each other. Further, they also help to stabilise adjacent wall modules as the tank is being constructed. This makes it easier to use the present invention. In addition, as flexible ties are tensioned the wall modules are brought closer together helping to improve the stability of the tank.

In a particularly preferred embodiment, the wall modules may be formed from a connection member and a wall panel.

Reference to the term “connection member” should be understood as meaning a component which can attach at least two wall panels to each other.

Preferably, the connection member provides rigidity to the wall panels and wall modules. This means that the panels can be made thinner and the tank is still easy to assemble and capable of supporting itself during assembly.

In a particularly preferred embodiment, the connection member may have two recesses configured to receive wall panels.

In the preferred embodiment, each connection member may have a wall panel secured within one of its recesses. The other recess is therefore available to receive the wall panel of an adjacent wall module. This is advantageous to the kitset according to the present invention as it is easier to assemble.

Preferably, the connection member may be shorter than the wall panels. The preferred length of the connection member may be 50-80 mm shorter than the wall panels. Therefore the top and bottom ends of the wall panels are able to be inserted into base elements and top frame segments. This will become clearer from the ensuing description.

In a particularly preferred embodiment the connection members may be configured to bear upon the top edge of at least one base element of the present invention.

Alternatively, connection members may have a portion corresponding to recesses in the base elements. Therefore, this portion may be inserted into the recesses of a base element. In yet a further embodiment, the connection member may sit between the edges of adjacent base elements.

Throughout the body of the present specification, the term “wall panels” should be understood as referring to substantially rectangular shaped panels which form the walls of the tank.

In a preferred embodiment, the wall panels may have dimensions in the order of:
550-850 mm width; and
1800-2200 mm height;
a depth of approximately 5 mm.

However, alternative dimensions for the wall panels are envisaged and it should be understood that these can be varied according to the size of the tank required, the materials from which the panels are made, or how the kitset of parts will be transported.

Alternatively, each wall module may be formed from a plurality of panels secured to each other. When positioning and securing the wall modules to each other, adjacent wall modules may overlap to facilitate securing them to each other.

In yet a further embodiment, the wall modules may have radially extending flanges along their side edges. These flanges may facilitate connecting adjacent wall panels to form the walls of the tank.

The wall modules or panels may also be corrugated, or have ridges along or across their body. This helps to improve the strength of the walls and to support them while the tank is being constructed.

In a preferred embodiment, the connection members and wall panels may have retainers.

In a particularly preferred embodiment the retainers may be a pair of corresponding ridges and channels in the recesses of connection members, and on the wall panels. Initially, the ridges provide a resistive force to the insertion of the wall panels into the recesses. This force is not so large that it cannot be overcome through pressure applied by a person.

Alternatively, the retainers may be shaped so that the wall panels must be slid along the length of the recesses to be inserted therein.

The retainers are beneficial as they assist in holding the wall modules in position while the tank is being assembled. They may also improve the strength of the tank once constructed.

Preferably the wall panels may have marker on at least one side edge. The markers may be formed during moulding of the wall panels, applied using paint or similar prior to sale of the tank, or etched into the wall panel.

The markers may indicate how far the wall panel must be inserted into a recess. This is important for construction of the tank and to ensure it is strong enough to hold large volumes/weights. It is also particularly important as they act as indicators to a person that flexible ties around the tank have been sufficiently tightened. This is discussed in more detail below.

In a particularly preferred embodiment, the wall modules may have a series of apertures to receive flexible ties. Preferably the apertures may be in the connection members. These apertures and the flexible ties will be discussed in detail below.

In a preferred embodiment, the wall modules may overlap the edges of adjacent base elements. This is particularly important in the embodiment where base elements receive portions of the wall modules. This may help to improve the strength of the tank as the edges of adjacent components do not sit over top of each other.

In a preferred embodiment, the present invention may include the step of positioning a plurality of flexible ties around the tank. Preferably the flexible ties may be wire ropes. Alternatively, the ties may be steel or plastic strapping.

In a particularly preferred embodiment, the flexible ties may be spaced above each other at different distances. The spacing of the flexible ties may be varied depending on the position of the ties at the tank's height. For instance, flexible ties may be spaced 10-15 centimeters apart in the range of 1 meter above the base elements, while flexible ties may be 70 centimeters apart towards the top 1 meter of the tank.

It should be appreciated that variations in the spacing of the flexible ties are possible. However, it is important that the ties are closer together towards the bottom of the tank. This is because, the pressure which liquid within the tank will exert is greater towards the bottom of the tank. Therefore, the tank needs additional hoop strength.

It should also be appreciated that the spacing of the flexible ties may be varied depending on the diameter of the tank, the density of the liquid within the tank, or the material from which the wall modules are constructed.

Once positioned, the flexible ties may be tensioned using a ratchet. This holds the wall modules tighter together. Tensioning may also pull the wall panels further into the recesses of the connection members. Therefore the overall stability of the tank is increased.

Tensioning continues until the markers indicate that the optimum position is achieved.

Throughout the body of the present specification the term “top frame segment” should be understood as a component which is positioned above the wall panels and vertical connection members.

In a preferred embodiment, the top frame segment may be located substantially at the perimeter of the structure, and above the wall modules.

In a preferred embodiment, the present invention may have a plurality of top frame segments extending around the perimeter of the structure.

In this embodiment, each top frame segment may have a recess which can accept a portion of at least one wall module. The bottom edge of the top frame segment may sit on top of at least one connection member.

The top frame segments can be positioned overtop of the wall modules. This preferably occurs once at least two wall modules have been positioned. The top frame segments may overlap the edges of adjacent wall modules and help to stabilise them during construction of the tank.

It is also envisaged that the top frame segments could be positioned once all of the wall modules have been positioned, or that top frame segments do not overlap the edges of adjacent wall modules.

In a particularly preferred embodiment, the top frame segments may have a tightening means. The tightening means may be configured to more tightly secure the top frame segments to the wall panel.

In one embodiment, the tightening means may be a plurality of screws extending through the top frame segments. By rotating the screws, it causes the edges of the recess to move towards or away from each cover. This means that the edges of the recess can grip the top edges of the wall modules.

In an alternate embodiment, the tightening means may be a spring biased clamp.

In a preferred embodiment, adjacent top frame segments could be attached to each other using joints. In one embodiment, the joints may extend into a portion of adjacent top frame segments. In another embodiment, the joints could extend over the edges of the adjacent top frame segments.

Using joints is useful as it helps to strengthen and stabilise the top frame segments and therefore the tank.

In a particularly preferred embodiment, the tank may include a bladder made from a flexible material such as polyethylene which can hold a liquid. This is as should be understood by those skilled in the art. However it is also envisaged that the present invention could be used without a bladder and that it may be capable of holding a fluid. Alternatively the structure could be a used as temporary accommodation for humans or animals. Therefore a bladder would not be needed to hold a liquid.

In a preferred embodiment, the tank may include connectors to secure the bladder inside the shell of the tank.

In one embodiment, the connectors may be corresponding hooks and eyelets, or button fasteners. Alternatively the connectors may be a band in the band which can be inserted into a recess in the shell. In this embodiment the recess may be integral to the wall modules either inside or outside the tank, or a recess on the outside of the top frame segments.

In a preferred embodiment, the tank may have a roof.

Preferably, the roof may include a support frame and a flexible cover.

In this embodiment, the support frame may be formed from tubular materials connected to form a spoke structure. Each arm of the spoke structure may have an attachment clip configured to fit over the top frame segment to secure the support frame in position.

Alternatively, the cover may be formed from a plurality of roof panels with a triangular shape. These may be connected and supported by a spoke or other appropriate structure, or be self supporting from the top frame segments.

In yet a further embodiment, a flexible cover could be used without using a spoke structure to support the cover. In this embodiment the flexible cover could extend over top of the tank shell.

Optionally, the present invention may include a bladder guard. Bladder guards may be positioned over portions of the bladder and the top frame segments to prevent damage to the bladder.

The clips of the roof spoke structure may fit overtop of the guard. Therefore, bladder guards prevent the clips and spoke structure from damaging the bladder.

Preferably, a series of tie downs may be used to secure the flexible cover to the tank thereby preventing unauthorised access into the tank.

In a particularly preferred embodiment, the flexible cover may have a series of eyelets about its edge to receive a tie for securing the cover to the tank. These eyelets allow a person to tightly secure the cover to tank thereby sealing it. Therefore insects or unwanted debris cannot get into the inside of the tank.

In addition, the cover may include a locking mechanism configured to prevent release of the cover and access inside the tank.

Preferably, this locking mechanism may be a padlock as known to those skilled in the art. However, the foregoing should not be seen as limiting and alternate embodiments for the cover are envisaged as within the scope of the present invention including those which do not utilise a support frame nor a flexible material.

In a preferred embodiment, the connection members may have apertures which facilitate attaching external securing devices to hold the tank in position.

In a particularly preferred embodiment, the external securing devices may be tent pegs or similar as known to those skilled in the art.

The use of tent pegs helps to ensure that when used as accommodation, shelter, other non-weighted applications, the present invention is unlikely to move in the wind or under other environmental conditions.

It should be appreciated that the method of constructing a tank is achieved using the components described above.

A kitset of parts is provided for use in constructing a tank.

Base elements each have a bottom wall panel inserted into a recess. These are secured to each other using techniques known to those skilled in the art. At least two base elements are positioned relative to where the tank is to be constructed. A portion of each base element is inserted into a recess of an adjacent base element.

Wall modules are provided. Each wall module is formed from a connection member with a wall panel secured in a recess of the connection member via techniques known to those skilled in the art.

At least two wall modules are positioned so that they bear upon at least one of the base elements. A portion of each wall module is inserted into a recess of the base element(s) upon which they bear.

Top frame segments are positioned above the wall modules. The top edge of each wall module extends into a recess of a top frame segment. The top frame segments overlap the edges of adjacent wall modules.

This process is repeated about the circumference of the structure to form the shell of the tank. The components of the tank are positioned so that walls modules overlap the edges of adjacent base elements.

Wire ropes are threaded through apertures in the connection members at different heights. The ropes are tensioned pulling the wall modules together.

The base elements and top frame segments overlap the edges of the wall modules. It is important that the connection members do not sit at the edges of adjacent base elements, nor top frame segments. This helps to ensure that the structure is stable and secure.

A bladder is positioned in the structure and secured via connectors.

The spoke structure of the roof is assembled and the clips fit over top of the top frame segments.

The flexible cover is spread over the top of the spoke structure and arranged so that there are no creases or tangles.

The flexible cover extends over the outside edge of the top frame segments.

A wire rope is threaded through eyelets on the edge of the flexible cover. The user pulls the rope tight to draw the edges of the cover into the tank shell thereby preventing insects in or debris getting into the tank.

The foregoing should not be seen as limiting and variations can be made thereto without departing from the scope there from.

The inventor has found that having the base elements and top frame elements overlap the wall modules makes it easier to construct a tank. Further, this method utilises less tools and can be easily assembled by one person on their own.

Each of the parts of the tank is small and light weight. The kitset of parts therefore occupies minimal space. It is cost effective to ship and distribute compared with structures available in the prior art.

### BRIEF DESCRIPTION OF DRAWINGS

Further aspects of the present invention will become apparent from the following description which is given by way of example only and with reference to the accompanying drawings in which:

FIG. 1 is a side view of a tank constructed according to the present invention;

FIG. 2 is a plan view of a base element;

FIG. 3 is an end on view of a member forming part of a base element;

FIG. 4 is a plan view of a connection member forming part of a wall module;

FIG. 5 is a perspective view of a base element, two wall modules, and a top frame segment;

FIG. 6 is a perspective view of a partially assembled tank;

FIG. 7 is a perspective view of a joint for connecting adjacent top frame segments;

FIG. 8 is a view of the partially constructed tank with a spoke structure in position;

FIG. 9A is a cross sectional view of the top edge of a wall module, top frame segment, and clip;

FIG. 9B is a perspective view of FIG. 9A;

FIG. 10 is a plan view through adjacent wall modules;

FIG. 11 is a cross sectional view through a base element, wall module, top frame segment, and roof of the present invention; and

FIG. 12 is a side view of a structure to be used as temporary accommodation.

### BEST MODES FOR CARRYING OUT THE INVENTION

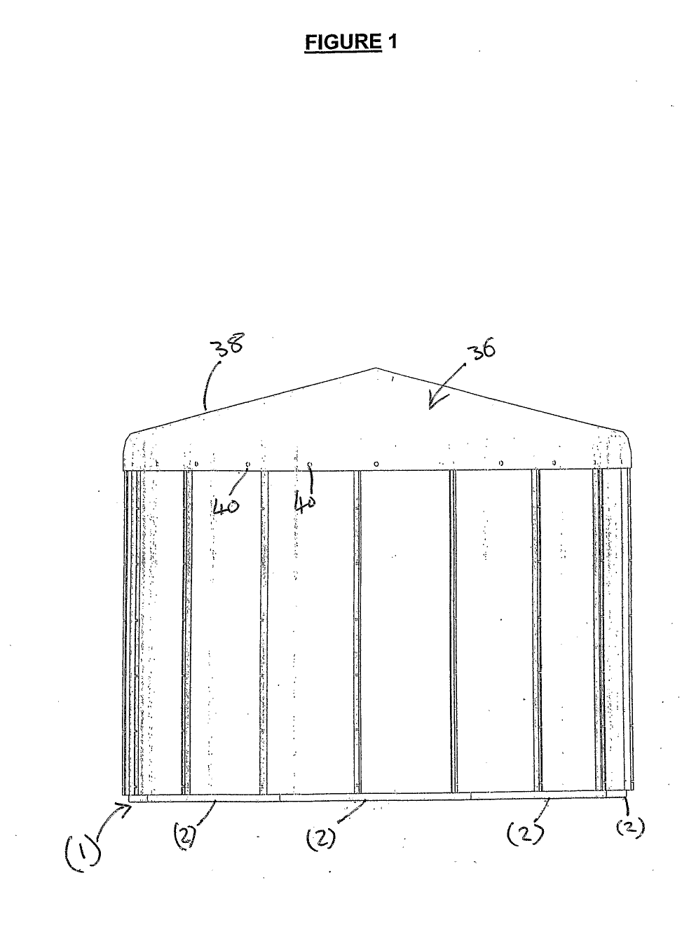

The present invention provides a multi-purpose demountable structure. The structure is shown as a tank (1) in its assembled form in FIG. 1. Reference is now made to the construction of the tank (1).

The tank (1) is sold as a kitset of parts. The components of the kitset are made from high density polyethylene plastic or similar materials. Alternatively the components of the present invention may be formed from aluminium, other plastic materials, or a combination of materials.

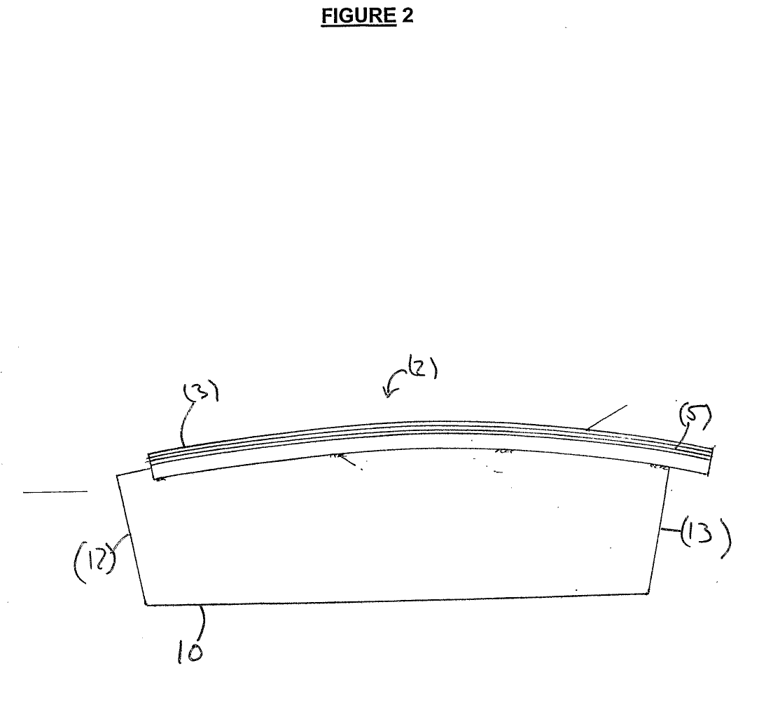

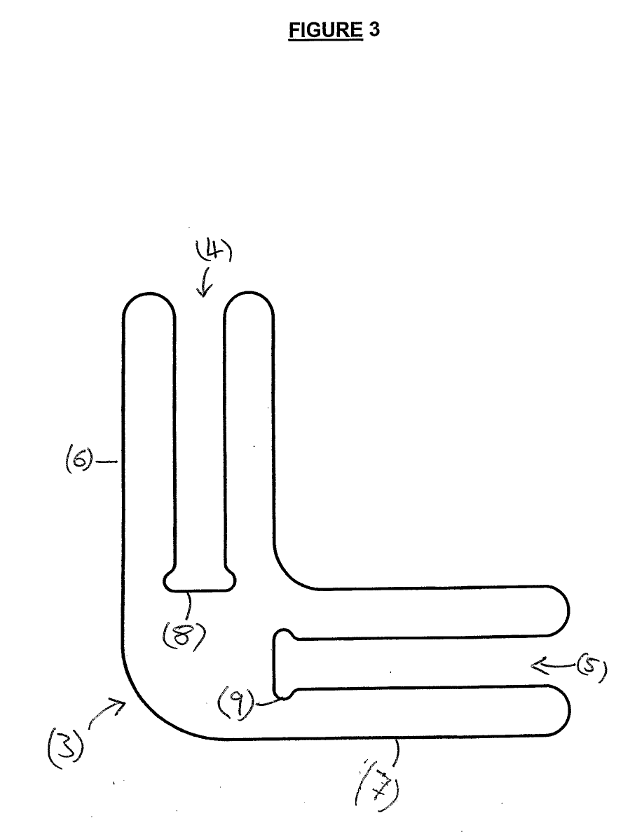

A base element (2) is shown in FIG. 2. The base element is formed from a member (3) having a substantially L shaped cross section. The member (3) has recesses (4 and 5) in each of its arms (6 and 7). FIG. 3 shows an end on view of the members (3). The member (3) has channels (8 and 9) in the recesses (4 and 5).

A floor panel (10) is inserted into the recess (4) so that it overlaps the end (11) of the member (3). The side edges (12, 13) of the floor panel (10) are shaped so that they can sit against the side edges of other floor panels in the tank (1).

The floor panel (10) is secured to the member (3) using a plastic weld or other technique known to one skilled in the art. This occurs prior to sale of the kitset.

Securing the floor panel (10) to the member (3) prior to sale offers a number of advantages and assists a person in constructing the tank (1) with minimal tools and effort.

A wall module (14) is formed from a connection member (15) and a wall panel (16).

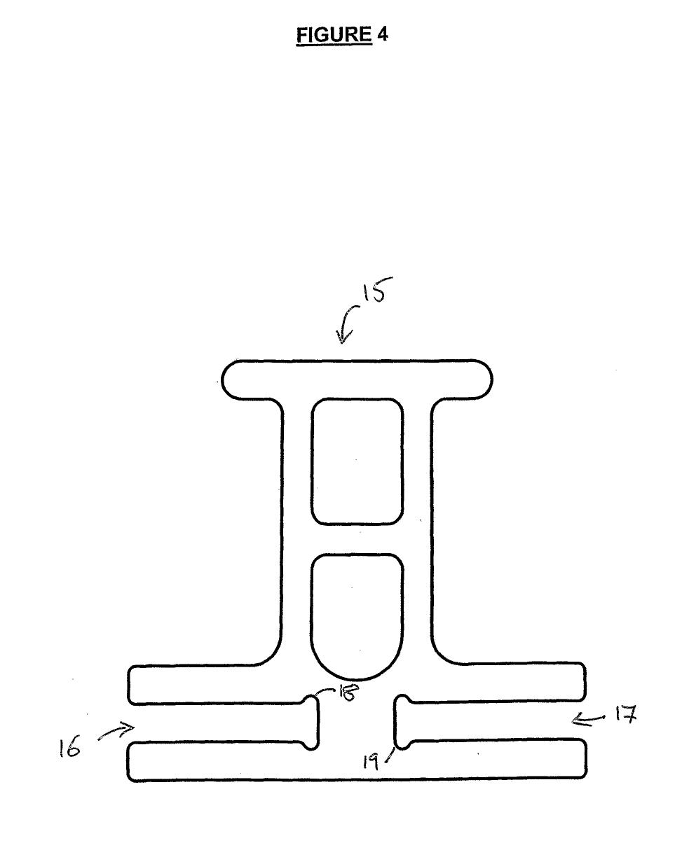

FIG. 4 shows a plan view of the connection member (15). The member (15) has recesses (16 and 17) and channels (18 and 19) in the recess.

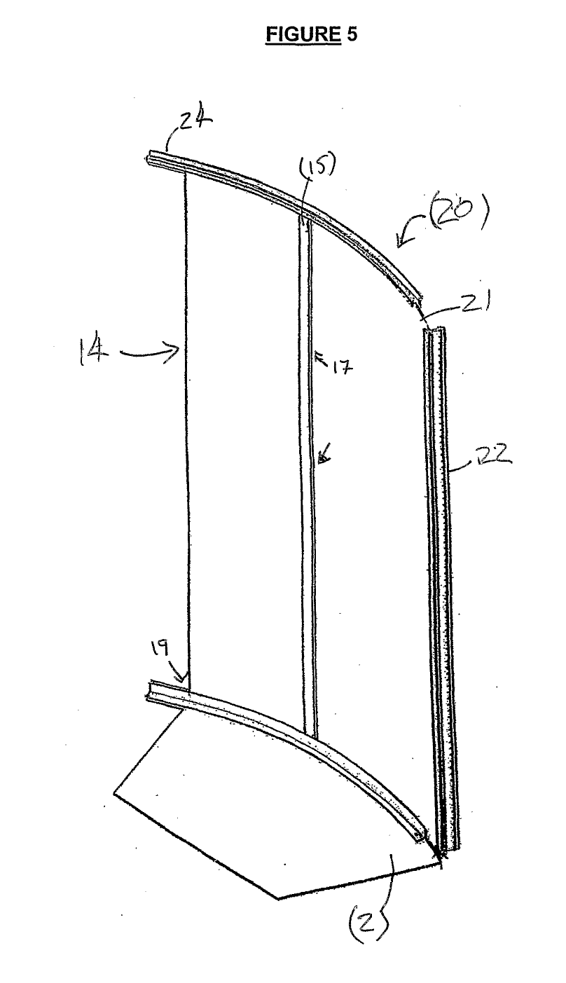

The wall module (14) can be seen in FIG. 5.

The wall panel (16) is inserted into the recess (16) of the connection member (15). The wall panel (16) has ridges (not shown) which correspond to the channels (18). These ridges provide resistance to insertion of the wall panel (16) into the recess (16). Once inserted, the ridges sit in the channels (18). This helps to retain the panel (16) in position once inserted into the recesses and may improve the stability of the tank during its assembly. The wall panel (16) is secured to the connection member (15) via a plastic weld prior to sale of the kitset.

The kitset includes a plurality of identical base elements (2) and wall modules (14). The number depends on the diameter of the tank being constructed.

A first base element (2) is positioned with respect to where the tank (1) is to be constructed.

The wall module (14) is positioned relative to a base element (2). The bottom edge (19) of the wall module (14) is inserted to the recess (5) of the base element (2).

A second wall module (20) is positioned and inserted into the recess (5) in the base element (2). The second wall module (20) is formed from a wall panel (21) and a connection member (22). The side edge (23) of the wall module (20) is inserted into a recess (17) in the connection member of the first wall module (14). FIG. 5 shows a base element (2) and wall modules (14 and 20).

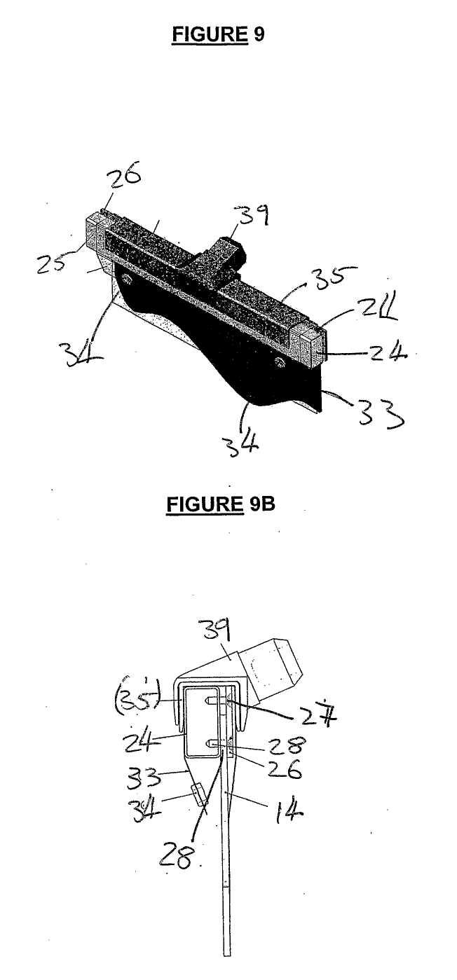

A top frame segment (24) can be seen in detail in FIGS. 9A and 9B. The top frame segment (24) is formed from a frame (25) and a plate (26). The frame (25) and plate (26) are secured to each other by screws (27). The size of the space (28) between the frame (25) and plate (26) can be changed by the screw (27).

A top frame segment (24) is positioned and engages the top edges (25) of the wall modules (14, 20) as shown in FIG. 5. The top frame segment (24) is positioned so that it overlaps the edges of adjacent wall modules (14, 20).

Another screw (28) can be inserted through the top frame segment (24) and a wall module (14 or 20).

The process of positioning wall modules (14, 20), base elements (2), and top frame segments (24) is repeated to form the shell (29) of the tank (21).

Portions of base elements (2) are inserted into the recesses (4) of adjacent base elements (2).

Joints (30) are used to connect adjacent top frame segments to each other. The joints (30) extend into the frame (25) of the top frame segments (24).

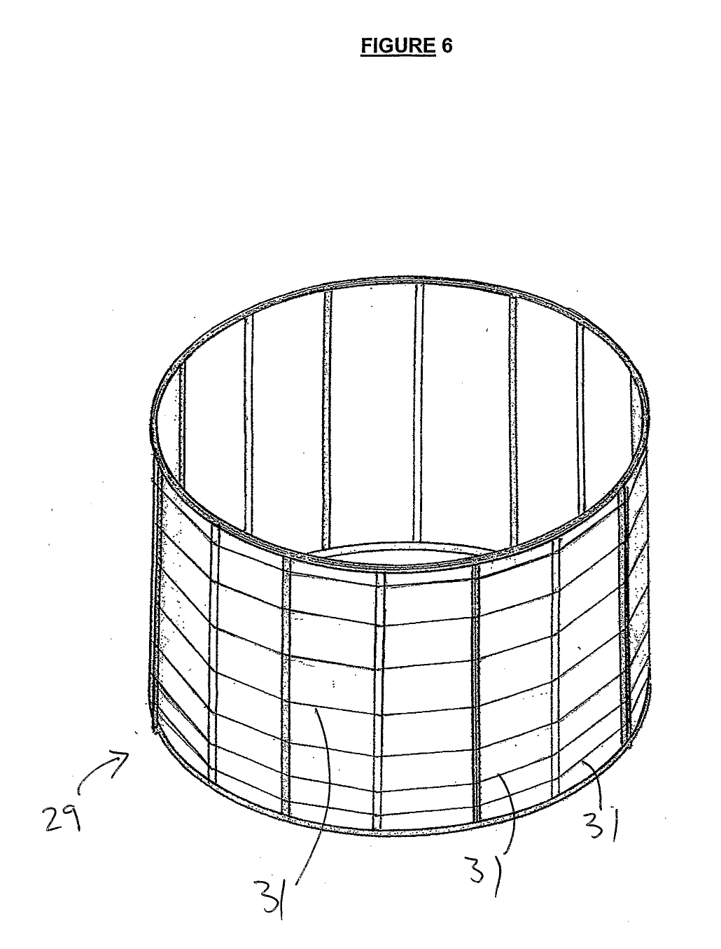

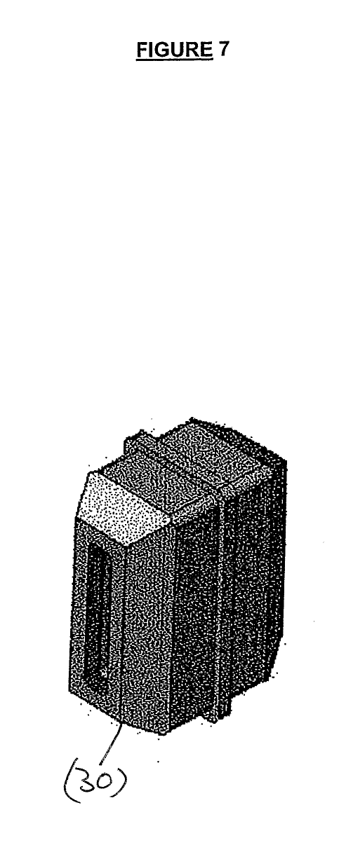

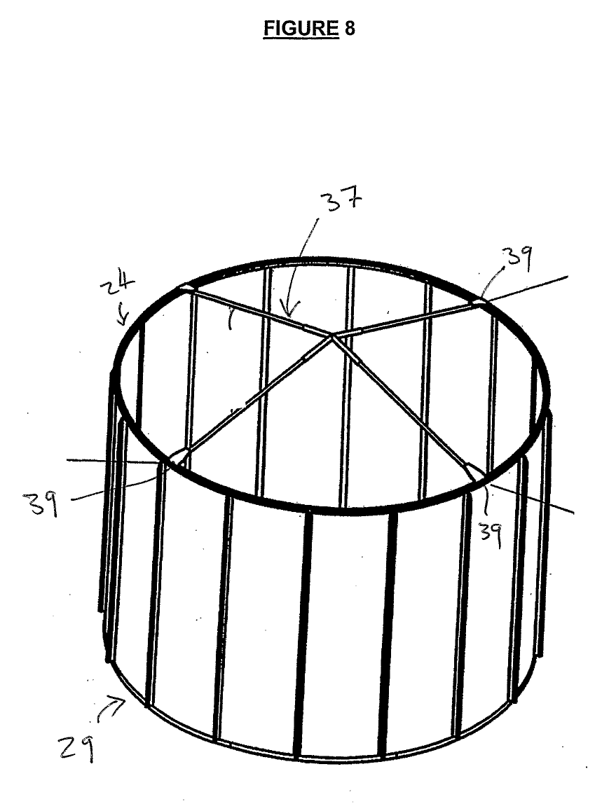

Wire ropes (31) are threaded through apertures (32) in each connection member (15). The ropes (31) are vertically spaced so that they impart hoop strength to the tank (1). This is shown in FIG. 6.

A bladder (33) formed from flexible material is installed in the tank (1). This ensures that the tank (1) can hold liquids or fine particulate matter.

The bladder (33) is secured to the tank (1) by button fasteners (34).

Bladder guard (35) is positioned over top of the bladder (1) and top frame segment (24).

A roof (36) is formed from a spoke structure (37) and a flexible cover (38). The spoke structure (37) is formed from tubular members (38). A clip (39) at the end of each member (37) fits over top of the bladder guards (36).

The flexible cover (38) is positioned over top of the spoke structure (37) overlapping the edge of the top frame segment (24).

Tie downs (not shown) are used to secure the cover (38) in place.

A wire rope (not shown) is threaded through eyelets (40) at the edges of the flexible cover (38). The rope (not shown) is pulled tight thereby drawing the edges of the cover (38) to the walls (14, 20) of the tank (1). This prevents access to the inside of the tank (1) reservoir or the cover (38) from flying off.

The cover (38) can be locked in place by a padlock (not shown) as known to one skilled in the art.

FIG. 9A shows a cross sectional view of the tank. The top frame segment (24) engages an edge of at least one wall panel. The bladder (33) is secured via button fasteners (34). The cover guard (35) is positioned and the clip (39) is in place to secure the roof (36).

FIG. 9B shows a perspective view of FIG. 9A.

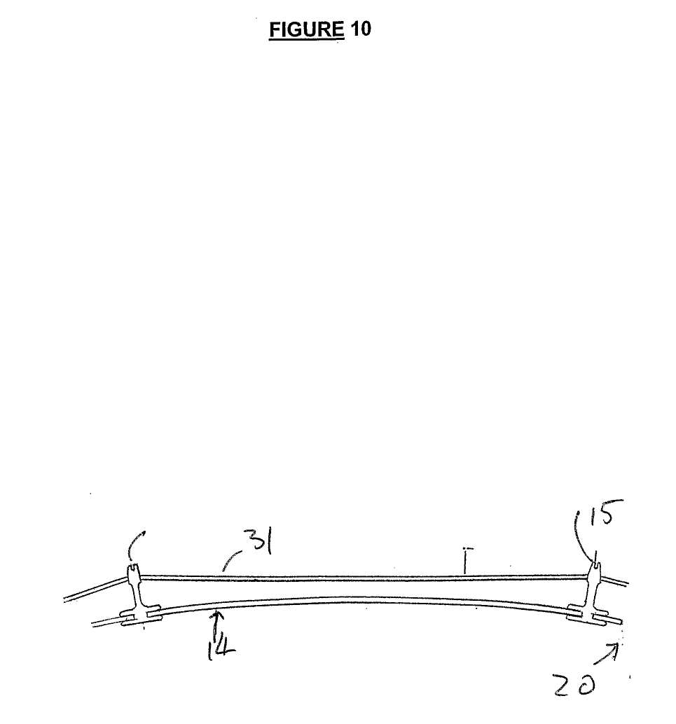

FIG. 10 shows a plan view through a wall module minus the top frame segments.

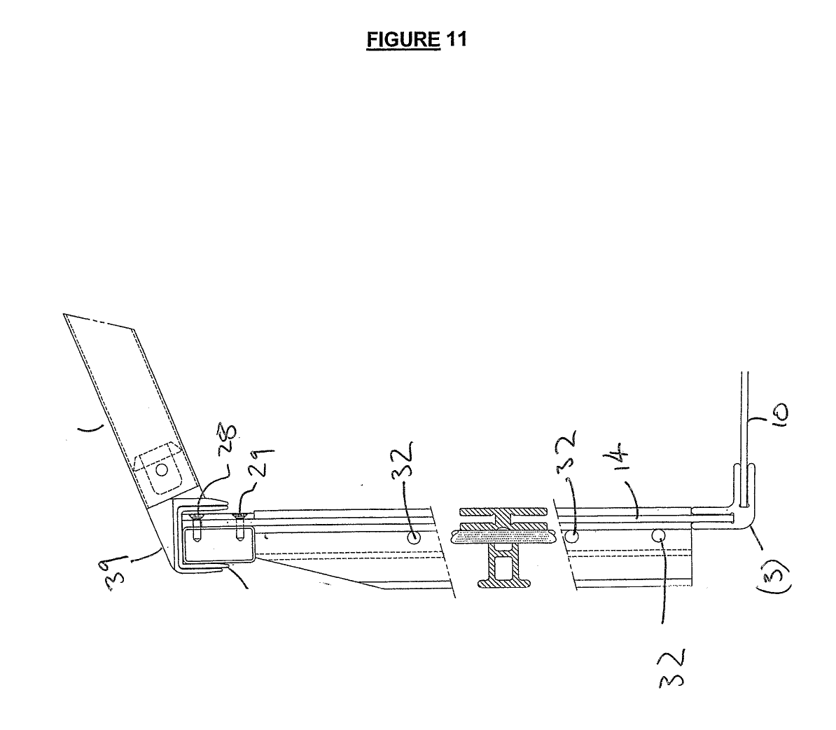

FIG. 11 shows a detailed cross sectional view of the tank.

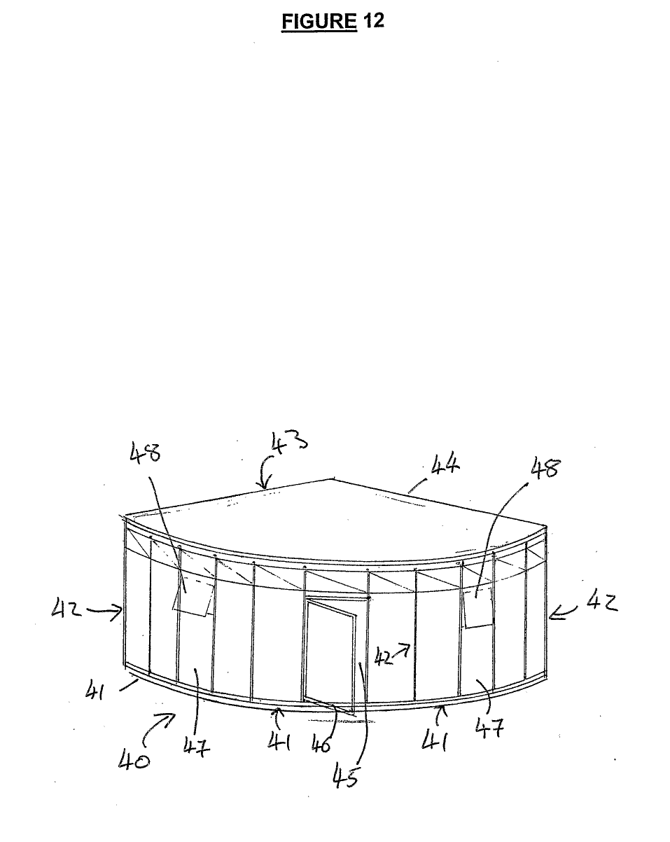

FIG. 12 shows a structure (40) as temporary accommodation according to the present invention.

The structure (40) is formed from a plurality of base elements (41) around the circumference of the structure (40). Wall modules (42) are connected to the base elements (41). Top frame segments (43) engage the top edge of the wall modules (42).

A roof (43) is formed from a spoke structure (not shown) which clips overtop of the top frame segments (43).

The flexible cover (44) is positioned overtop of the spoke structure (not shown).

Wall panel (45) is amended to provide a door (46).

Wall panels (47) are altered to provide windows (48).

A bladder is not needed in structure (40) as this does not hold liquids or particulate matter. Rather, the structure (40) can be used to provide temporary accommodation to humans or animals.

It should be apparent from the foregoing description that the present invention has numerous advantages over the prior art and previously available structures. These include that:
One person can easily and quickly assemble the demountable structure;
Minimal tools are required;
No technical skills or experience are necessary to assemble the present invention;
When being shipped, the demountable structure occupies minimal space and that it is therefore considerably cheaper to ship and distribute.

However there is no need to use a bladder as the structure does not hold fluids or particulate matter. A wall panel ( ) is modified to provide a door ( ). Wall panels ( ) are also modified to provide windows ( ) or ventilation openings ( ).

It should also be appreciated that the present invention is capable as acting as a temporary shelter or providing accommodation to those in need. The ability of the present invention to occupy minimal space when disassembled makes it particularly suitable for this purpose. That being, its transportation costs are minimal and it is capable of being delivered to a variety of locations where traditional road or rail networks are unavailable.

Further, the present invention is considerably lighter than the demountable structures known in the prior art. This decreases costs associated with transportation of the invention and helps to ensure that it can be easily constructed by users.

The present invention is also capable of being easily dismantled and subsequently assembled in a different location.

Aspects of the present invention have been described by way of example only and it should be appreciated that modifications and additions may be made thereto without departing from the scope thereof.

1.-26. (canceled)

27. A method of constructing a cylinder shaped structure, including the steps of:
forming the structure by:
(a) positioning a first base element with respect to where the structure is to be constructed;
(b) positioning a second base element adjacent to the first base element;
(c) inserting a portion of each base element into a recess of an adjacent base element;
(d) positioning a first wall module such that it bears upon at least one of the base elements;
(e) positioning a second wall module adjacent to the first wall module such that it bears upon at least one of the base elements;
(f) positioning a top frame segment to overlap the edges of adjacent wall modules;
(g) repeating steps a)-f) to substantially form the shell of the structure; and
(h) securing a bladder inside the structure.

28. The method as claimed in claim 27, including the step of inserting a portion of each wall module into the base elements on which it bears.

29. The method as claimed in claim 28, including the step of inserting a portion of each wall module into a recess of an adjacent wall module.

30. The method as claimed in claim 27, including the step of positioning a plurality of flexible ties around the outside of the structure.

31. The method as claimed in claim 30, including the step of threading the flexible ties through apertures in the wall modules.

32. The method as claimed in claim 30, including the step of tensioning the flexible ties to secure the wall modules.

33. The method as claimed in claim 27, including the step of constructing a roof for the structure.

34. The method as claimed in claim 33, wherein the step of constructing the roof includes constructing and securing a spoke structure to the shell of the tank.

35. The method as claimed in claim 34, including the step of positioning and securing a flexible cover over the top of the spoke structure.

36. A cylinder shaped structure including,
(a) a plurality of base elements, wherein a portion of each base element extends into a recess of an adjacent base element;
(b) a plurality of wall modules, wherein each wall module bears on at least one of the base elements;
(c) a plurality of top frame segments that overlap the edges of adjacent wall modules; and
a bladder is secured inside the structure.

37. The structure as claimed in claim 36, wherein the wall modules overlap the edges of adjacent base elements.

38. The structure as claimed in claim 36, including a plurality of flexible ties around the outside of the tank.

39. The structure as claimed in claim 38, wherein the flexible ties extend through apertures in the wall modules.

40. The structure as claimed in claim 36 including a roof.

41. The structure as claimed in claim 40, wherein the roof is a flexible cover.

42. A kitset of parts for constructing a cylinder shaped structure, the kitset including:
(a) a plurality of base elements, wherein a portion of each base element extends into a recess of an adjacent base element once the structure is constructed;
(b) a plurality of wall modules which bear on one base element once the structure is constructed;
(c) a plurality of top frame segments configured for overlapping the edges of adjacent wall modules once the structure is constructed; and
(d) a bladder that is securable inside the structure.

43. The kitset as claimed in either claim 42, including a frame and flexible cover configured for providing a cover for the cylinder shaped structure once constructed.
